(19) United States
(12) Patent Application Publication
(10) Pub. No.: US 2025/0002628 A1
(43) Pub. Date: Jan. 2, 2025

(54) COPOLYMERS COMPRISING (PER)FLUOROPOLYETHER CHAINS

(71) Applicant: SOLVAY SPECIALTY POLYMERS ITALY S.P.A., Bollate (Milano) (IT)

(72) Inventors: Ugo De Patto, Cogliate (MB) (IT); Andrea Lotierzo, Brugherio (MB) (IT); Pier Antonio Guarda, Arese (MI) (IT)

(73) Assignee: SOLVAY SPECIALTY POLYMERS ITALY S.P.A., Bollate (Milano) (IT)

(21) Appl. No.: 18/575,240

(22) PCT Filed: Jun. 23, 2022
(86) PCT No.: PCT/EP2022/067112

§ 371 Date: Dec. 28, 2023

(30) Foreign Application Priority Data
Jul. 1, 2021 (EP) 21183256.3

(51) Int. Cl. C08F 283/06; C08L 51/08

(52) U.S. Cl. CPC C08F 283/06; C08L 51/08; C08L 2205/02

(57) ABSTRACT

The present patent application relates to copolymers comprising (per)fluoro-polyether chains, characterized by increased viscosity.

### CROSS-REFERENCE TO RELATED PATENT APPLICATIONS

This application claims priority filed on 1 Jul. 2021 in EUROPE with Nr. 21183256.3, the whole content of this application being incorporated herein by reference for all purposes.

### TECHNICAL FIELD

The present patent application relates to copolymers comprising (per)fluoropolyether chains, characterized by increased viscosity.

### BACKGROUND ART

Lubrication is an important aspect of maintaining machinery in proper operating condition. Machine elements such as bearings, pins, shafts, gears and joints require proper lubrication between their moving surfaces to decrease friction, prevent contamination, reduce wear and dissipate heat. Improper lubrication is likely to lead to premature component wear and component or system failure.

(Per)fluoropolyether polymers (in the following referred to as “PFPE polymers”) have been long known as base oils or as additives in several lubricant applications.

Several syntheses of PFPE polymers have been disclosed in the art. The first synthesis of unspecified perfluorinated polyether mixtures was reported in 1953, when an oily product was obtained in the course of photoligomerization of hexafluoropropene. Since then, a number of different perfluorinated polyethers have been synthesized and described in literature.

U.S. Pat. No. 4,500,739 (in the name of Montedison) discloses the reaction of a peroxidic PFPE with—among the others—perfluoro butadiene (Group II of fluoroolefins). Example 4 discloses the reaction with perfluoro butadiene, with a large excess of perfluorinated bis-olefin, resulting in pendant unsaturated groups along the macromolecular chain such that the reaction can further proceed in the presence of hexamethylenediamine.

U.S. Pat. No. 8,258,090 B2 (in the name of Solvay Solexis S.p.A.) discloses fluorinated lubricants of formula:

T-O—[A-B]z-[A′-B′]2′-A-T (I)
wherein
T and T′ are C₁₋₃ perfluoroalkyl or C₁₋₆ alkyl,
A and A are a perfluoropolyether chain,
B derives from two different olefins, of which at least one homopolymerizable by radical route, of formula:

—[(CR₁R₂—CR₃R₄)ⱼ—(CR₅R₆—CR₇R₈)_{j′}]— (Ia)
wherein
j is from 1 to 5, j′ is from 0 to 4 and the sum of j+j′ is between 2 and 5; R₁ to R₈ are halogen, H, C₁₋₆ (per)haloalkyl, C₁₋₆ alkyl, C₁₋₆ oxy(per)fluoroalkyl; z is higher than or equal to 2, z′ is an integer and the sum of z and z′ is such that the number average molecular weight of the polymer of formula (I) is in the range 500-500000;
B′ is (Ia) but at least one of R₁ to R₈ has a meaning different from that in B.

This patent discloses block copolymers characterized by a linear backbone, without any branching. Indeed, no branching is obtained within B, notably comprising (per)fluoropolyether chains.

Polymers obtained using PFPE polymeric units have been disclosed in the art. Crossed-linked fluoroelastomers are among those. On this regard, S. P. Krukovsky et al.—J of Fluorine Chemistry 96 (1999) 31-33—disclosed copolymerization of perfluoroalkyleneoxides containing peroxide groups in the chain with perfluorodivinyl ethers under UV radiation and heating to provide cross-linked polymers, referred to as elastomers. This document does not disclose any amount for the reactants, and does not address a method for manufacturing polymers suitable for use for lubricants.

### SUMMARY OF INVENTION

While research and development in the recent years focused on mono- and/or bi-functional (per)fluoropolyether (PFPE) polymers, the Applicant perceived that there is still the need for providing neutral PFPE polymers that can be used as lubricants.

The Applicant faced the problem of providing new neutral PFPE polymers characterized by an increased viscosity (as measured by complex viscosity at 0.1 rad/s at 25° C.), while maintaining low glass transition temperature (Tg) and still being in the liquid state at room temperature.

The Applicant surprisingly found that neutral branched (per)fluoropolyether polymers characterized by increased viscosity, due to an increase of the number average molecular weight, can be provided via a process easy to implement on industrial scale.

Advantageously, the process allows to manufacture neutral (per)fluoropolyether polymers having high thermal stability while maintaining a low glass transition temperature and a good viscosity index (ASTM D2270), such that such polymers are particularly useful as lubricants in harsh environments, including for example applications requiring wide range of working temperatures or high heat generation.

In a first aspect, the present invention relates to a block copolymer [copolymer (P)] comprising a first and a second (per)fluoropolyether chain [PFPE chain] each having two chain ends, wherein the first chain end of said first and second PFPE chain comprises a perfluorinated alkyl group and the second chain end of said first and second PFPE chain are bonded to each other via:
a first block [block (1)] complying with formula (I):

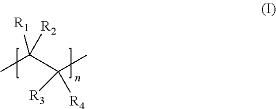

wherein
n is 0 or an integer from 1 to 3;
R₁ to R₄, each independently, is selected in the group comprising, preferably consisting of, fluorine atom, perfluorinated linear or branched alkyl group having from 1 to 6 carbon atoms, group of formula (II):

—(R₁₀)ₜ[C(R₁)(R₂)—C(R₁₃)(R₁₄)(R₁₅)]_{z} (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected in the group comprising, preferably consisting of, fluorine atom, perfluorinated linear or branched alkyl group having from 1 to 6 carbon atoms and group of formula (III):

-[(A\hat{ })_{a\hat{ }}-(B\hat{ })_{v\hat{ }}-(E\hat{ })_{L\hat{ }}]_{u\hat{ }}-(C\hat{ })-T (III)
wherein
a\hat{ } is zero or 1,
v\hat{ } is zero or an integer from 1 to 3,
L\hat{ } is zero or an integer from 1 to 250,
u\hat{ } is zero or an integer from 1 to 50;
A\hat{ } is a PFPE chain
B\hat{ } is a group of formula:

—[C(R_{1\hat{ }})(R_{2\hat{ }})—C(R_{3\hat{ }})(R_{4\hat{ }})]—
wherein R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, more preferably fluorine or chlorine atom, and
R_{102\hat{ }} and R_{103\hat{ }} are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
and
   a second block [block (2)] complying with formula (IV):

—[(CR^{1*}R^{2*}CR^{3*}R^{4*})_{n*}-(E)_{L}]— (IV)
wherein
n* is zero or an integer from 1 to 10,
L is zero or an integer from 1 to 250;
each of R^{1*} to R^{4*} is selected in the group comprising, preferably consisting of, fluorine atom, perfluorinated linear or branched alkyl group having from 1 to 6 carbon atoms, group of formula (II) as defined above,
E has the same meaning provided for E\hat{ } above;
with the proviso that:
in said copolymer (P)
   the sum of (n+n*+v\hat{ }) is from 1 to 15, preferably from 1 to 11, more preferably from 1 to 9;
   the sum of (L+L\hat{ }) is from 1 to 500, preferably from 2 to 500, more preferably from 2 to 300,
   said block (1) and said block (2) are statistically distributed; in said formula (I):
   at least one of R₁ to R₄ is a group of formula (II),
   one of R₁₁ or R₁₂ and one of R₁₃ to R₁₅, is a group of formula (III); in said formula (III) and said formula (IV)
   the recurring units are statistically distributed, in said formula (III)
   when a is 1 at least one of v\hat{ } and L\hat{ } is different from 0, and in said formula (IV)
   at least one of n* and L is different from zero.

In a second aspect, the present invention relates to a process [process (P)] for the manufacture of copolymer (P) as defined above.

Advantageously, copolymer (P) according to the present invention is prepared via a process [process (P)], which comprises contacting:
at least one (per)fluoropolyether polymer comprising peroxidic groups [PFPE peroxy];
at least one perfluorinated compound of formula (X-p):

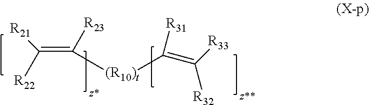

wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally and preferably interrupted by and/or comprising at least one oxygen atom,
t is zero or 1, preferably 1;
each of z* and z** is independently 1 or 2; and
at least one compound [compound (O)] selected in the group comprising, preferably consisting of:
(i) fully halogenated olefin comprising from 2 to 8 carbon atoms, preferably tetrafluoroethylene (TFE), hexafluoropropylene (HFP), chlorotrifluoroethylene (CTFE);
(ii) CF₂═CFOR_{f},
wherein
R_{f} is a C₁-C₆ (per)fluoroalkyl group, preferably —CF₃, —C₂F₅, —C₃F₇ (also referred to as “PAVE” hereinafter); a group C₁-C₁₂ [(per)fluoro]-oxyalkyl comprising catenary oxygen atoms, preferably perfluoro-2-propoxypropyl group (also referred to as “perfluoro-oxy-alkyl-vinyl ethers” hereinafter); a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R_{f2} is —CF₂CF₃ (MOVE1), —CF₂CF₂OCF₃ (MOVE2), or —CF₃ (MOVE3);
(iii) perfluorodioxoles having formula

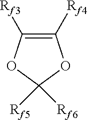

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃; in the presence of UV radiation or under heating,
provided that the amount of the compound of formula (X-p) is less than 5 wt. % of the amount of the PFPE peroxy.

In the process according to the present invention, it is important that the amount of the compound of formula (X-p) is properly selected to be lower than the amount of the PFPE peroxy.

Advantageously, by selecting such amount, more than 85%, more preferably more than 90% and even more preferably more than 95% of the unsaturated moieties of compound of formula (III) react with at least one peroxy group of the starting PFPE peroxy, and branched block copolymers (P) free from unsaturated moieties as pendant groups (also referred to as “functional groups”) are obtained.

Copolymer (P) is advantageously free from pendant groups comprising any moiety capable of undergoing a further chemical reaction. In particular, copolymer (P) is free from unsaturated moieties as pendant groups.

In a third aspect, the present invention relates to copolymer (P) obtained via process (P) as described above.

While purification steps can be performed at the end of said process (P), it will be clear to those skilled in the art that the copolymers (P) according to the present invention are obtained at the end of process (P) as a mixture.

Thus, in a further aspect, the present invention relates to a mixture [mixture (P)] comprising two or more copolymers (P) as defined above.

It will be clear to those skilled in the art that mixture (P) is obtained via process (P) as described above.

Advantageously, said mixture (P) can be subjected to one or more purification steps (also referred to as “fractionation” steps), thus obtaining separate copolymers (P) characterized by different viscosities.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural form, depending on the context;
the term “(per)fluoropolyether” is intended to indicate fully or partially fluorinated polyether polymer.

### Copolymer (P)

Advantageously, said copolymer (P) is characterized by a complex viscosity, measured at 0.1 rad/s and at 25° C., from 10 Pa*s to 2000 Pa*s.

It will be understood by those skilled in the art that said first chain end of said first and second PFPE chain correspond to the two chain ends of copolymer (P).

Preferably, said first chain end of said first and second PFPE chain comprise a perfluorinated linear alkyl group having from 1 to 3 carbon atoms.

Preferably, said perfluorinated alkyl groups are the same from each other.

Preferably, said first chain end of said first and second PFPE chain and said T in formula (III), equal or different from each other, are a perfluorinated alkyl group having from 1 to 3 carbon atoms.

Preferably, said first and second PFPE chain, said A\hat{ } and said C\hat{ } are equal or different from each other.

Preferably, in copolymer (P), said first PFPE chain is bonded to said block (1) via a sigma bond or a group —(C)— selected from —CF₂—, —CF₂CF₂— or —O—.

Preferably, in copolymer (P), said block (2) is bonded to said second PFPE chain via a sigma bond or a group —(C)— selected from —CF₂—, —CF₂CF₂— or —O—.

Preferably, when both said block (1) and said block (2) are present, they are linked via a sigma bond.

Preferably, in said copolymer (P), each of said PFPE chain is a partially or fully fluorinated chain [chain (R_{f})] comprising, preferably consists of, repeating units R^{o}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, chain (R_{f}) complies with the following formula:

—[(CFX¹O)_{g1}(CFX²CFX³O)_{g2}(CF₂CF₂CF₂O)₉₃(CF₂CF₂CF₂CF₂O)_{g4}]— (R_{f}—I)
wherein
   X¹ is independently selected from —F and —CF₃,
   X², X³, equal or different from each other and at each occurrence, are independently —F, —CF₃, with the proviso that at least one of X is —F;
   g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (R_{f}—IIA)
wherein:
   a1 and a2 are independently integers 0 such that the number average molecular weight is between 400 and 10,000, preferably between 400 and 5,000;
both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b4}]— (R_{f}—IIB)
wherein:
b1, b2, b3, b4, are independently integers 0 such that the number average molecular weight is between 400 and 10,000, preferably between 400 and 5,000; preferably b1 is 0, b2, b3, b4 are ≥0, with the ratio b4/(b2+b3) being 1;

—[(CF₂CF₂O)_{c1}(CF₂O)_{c2}(CF₂(CF₂)_{cw}CF₂O)_{c3}]— (R_{f}—IIC)
wherein:
cw=1 or 2;
c1, c2, and c3 are independently integers 0 chosen so that the number average molecular weight is between 400 and 10,000, preferably between 400 and 5,000; preferably c1, c2 and c3 are all ≥0, with the ratio c3/(c1+c2) being generally lower than 0.2.

Still more preferably, chain (R_{f}) complies with formula (R_{f}—μl) here below:

—[(CF₂CF₂O)ₐ₁(CF₂O)ₐ₂]— (R_{f}—III)
wherein:
   a1, and a2 are integers ≥0 such that the number average molecular weight is between 400 and 10,000, preferably between 400 and 5,000, with the ratio a1/a2 being generally comprised between 0.1 and 10, more preferably between 0.2 and 5.

Preferably, in formula (I), at least one of substituents R₁ to R₄ is a group of formula (II) and the other substituents are each independently selected from a fluorine atom or a perfluorinated alkyl chain having from 1 to 3 carbon atoms, more preferably a fluorine atom or a perfluorinated alkyl chain having 1 carbon atoms.

According to one embodiment, in formula (II), t is 0.

According to another embodiment, in formula (II) t is 1 and R₁₀ complies with one of the following formulae:

—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and
R_{CF} is either a perfluoroalkyl chain comprising from 1 to 12, preferably from 1 to 8 carbon atoms, optionally interrupted by one or more oxygen atoms

—O—(C₃F₆O)ₕ—(CF₂)ᵢ—(C₃F₆O)ⱼ—O— (R₁₀-ii)
wherein h=j and h+j is from 2 to 6, and i is from 2 to 6.

According to this embodiment, preferably R₁₀ complies with formula:

—(CF₂)_{d}(O)ₑ(CF₂O)_{f}R_{CF}(O)_{e*}(CF₂)_{d*}(CF2O)_{f*} (R₁₀-i)
wherein
d, f, d* and f* are zero,
e and e* are 1, and
R_{CF} is a linear perfluoroalkyl chain comprising from 1 to 10, preferably from 1 to 8 carbon atoms.

Preferably, in formula (II), z is equal to 1 and R₁₀ is an oxygen atom or a bivalent perfluorinated alkyl chain comprising from 1 to 24 carbon atoms and being optionally interrupted by and/or comprising at least one oxygen atom.

Preferably, in formula (II), one of substituents R₁₁ and R₁₂ is a group of formula (III) and the other substituent is selected from a fluorine atom or a perfluorinated alkyl chain having from 1 to 3 carbon atoms, more preferably a fluorine atom or a perfluorinated alkyl chain having 1 to 3 carbon atoms. According to a preferred embodiment, one of substituents R₁₁ and R₁₂ is a group of formula (III) and the other substituent is a fluorine atoms.

Preferably, in formula (II), one of substituents R₁₃ to R₁₅ is a group of formula (III) and the other two substituents are independently selected from a fluorine atom or a perfluorinated alkyl chain having from 1 to 3 carbon atoms, more preferably a fluorine atom or a perfluorinated alkyl chain having 1 carbon atoms. More preferably said two substituents are the same and are a fluorine atom.

Preferably, in formula (III), v\hat{ } is an integer from 1 to 3, more preferably 1.

Preferably, in formula (III), L\hat{ } is an integer from 1 to 250, more preferably from 2 to 250.

Preferably, in formula (III), -(E\hat{ })_{L\hat{ }}- complies with the following formula:

—(CR_{100\hat{ }}R_{101\hat{ }}CR_{102\hat{ }}R_{103\hat{ }})_{l\hat{ }}—(CR_{110\hat{ }}R_{111\hat{ }}CR_{112\hat{ }}R_{113\hat{ }})_{m\hat{ }}—
wherein
l\hat{ } and m\hat{ } are each independently an integer from 1 to 250, more preferably from 2 to 250, such that the sum of L+m is from 2 to 250;
R_{100\hat{ }}, R_{101\hat{ }}, R_{110\hat{ }} and R_{111\hat{ }} are independently selected from halogen atom, more preferably fluorine or chlorine atom, and R_{102\hat{ }}, R_{103\hat{ }}, R_{112\hat{ }} and R₁₁3\hat{ } are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms; or
one of R_{110\hat{ }} and R_{111\hat{ }} and one of R_{112\hat{ }} and R_{113\hat{ }} are a fluorine atom and the other of R_{100\hat{ }} and R_{101\hat{ }} and the other of R_{112\hat{ }} and R_{113\hat{ }} together form a perhalogenated cyclic ring having from 4 to 6 members, optionally comprising heteroatoms, such as oxygen atoms;
with the proviso that —(CR_{100\hat{ }}R_{101\hat{ }}CR_{102\hat{ }}R_{103\hat{ }})_{l\hat{ }}— and —(CR_{110\hat{ }}R_{111\hat{ }}CR_{112\hat{ }}R_{113\hat{ }})_{m\hat{ }}— are different from each other and statistically distributed.

Preferably, in formula (IV), n* is an integer from 1 to 10, more preferably from 1 to 5, even more preferably from 1 to 3, and still more preferably 1.

Preferably, in formula (IV), L is an integer from 2 to 250.

Preferably, in formula (IV), -(E)_{L}- complies with the following formula:

—(CR₁₀₀R₁₀₁CR₁₀₂R₁₀₃)ₗ—(CR₁₁₀R₁₁₁CR₁₁₂R₁₁₃)ₘ—
wherein
l and m are each independently an integer from 1 to 250, more preferably from 2 to 250, such that the sum of L+m is from 2 to 250;
R₁₀₀, R₁₀₁, R₁₁₀ and R₁₁₁ are independently selected from halogen atom, more preferably fluorine or chlorine atom, and
R₁₀₂, R₁₀₃, R₁₁₂ and R₁₁₃ are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms, such as oxygen atoms; or
one of R₁₁₀ and R₁₁₁ and one of R₁₁₂ and R₁₁₃ are a fluorine atom and the other of R₁₁₀ and R₁₁₁ and the other of R₁₁₂ and R₁₁₃ together form a perhalogenated cyclic ring having from 4 to 6 members, optionally comprising heteroatoms, such as oxygen atoms;
with the proviso that —(CR₁₀₀R₁₀₁CR₁₀₂R₁₀₃)ₗ— and —(CR₁₁₀R₁₁₁CR₁₁₂R₁₁₃)ₘ— are different from each other and statistically distributed.

Preferably, in formula (IV), I is an integer from 1 to 250.

According to a first preferred embodiment, the copolymer (P) according to the present invention (hereinafter referred to as “copolymer (P-1)”) is a block copolymer comprising a first and a second PFPE chain, each having two chain ends, wherein the first chain end of said first and second PFPE chain comprises a perfluorinated alkyl group and the second chain end of said first and second PFPE chain are bonded to each other via:
a block complying with formula (IV):

—[(CR^{1*}R^{2*}CR^{3*}R^{4*})_{n*}-(E)_{L}]- (IV)
wherein
n* is an integer from 1 to 10, preferably from 1 to 5, more preferably from 1 to 3, even more preferably 1;
L is zero or an integer from 1 to 250, more preferably from 2 to 250; each of R^{1*} to R^{4*} is selected in the group comprising, preferably consisting of, fluorine atom, perfluorinated linear or branched alkyl group having from 1 to 3 carbon atoms, group of formula (II):

—(R₁₀)ₜ[C(R₁₁)(R₁₂)—C(R₁₃)(R₁₄)(R₁₅)]_{z} (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected in the group comprising, preferably consisting of, fluorine atom, perfluorinated linear or branched alkyl group having from 1 to 3 carbon atoms and group of formula (III):

—[(A\hat{ })_{a\hat{ }}-(B\hat{ })_{v\hat{ }}-(E\hat{ })_{L\hat{ }}]_{u\hat{ }}-(C\hat{ })-T (III)
wherein
a\hat{ } is zero or 1,
v\hat{ } is zero or an integer from 1 to 3,
L\hat{ } is an integer from 1 to 250, preferably from 2 to 250,
u\hat{ } is an integer from 1 to 50;
A\hat{ } is a PFPE chain,
B\hat{ } is a group of formula —[C(R_{1\hat{ }}) (R_{2\hat{ }})C(R_{3\hat{ }})(R_{4\hat{ }})]—
wherein R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, more preferably fluorine or chlorine atom, and
R_{102\hat{ }} and R_{103\hat{ }} are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
E has the same meaning provided for E\hat{ } above;
with the proviso that
in said copolymer (P-1):
   the sum of (n*+v\hat{ }) is from 1 to 15,
   the sum of (L+L\hat{ }) is from 2 to 500, preferably from 3 to 300, more preferably from 4 to 250, and
   the recurring units in formulae (Ill) and (IV) are statistically distributed; and
in said formula (IV):
   at least one of R_{1\hat{ }} to R_{4\hat{ }} is a group of formula (II),
   one of R₁₁ or R₁₂ and one of R₁₃ to R₁₅, is a group of formula (III).

According to a second preferred embodiment, the copolymer (P) according to the present invention (hereinafter referred to as “copolymer (P-2)”) is a block copolymer comprising a first and a second PFPE chain, each having two chain ends, wherein the first chain end of said first and second PFPE chain comprises a perfluorinated alkyl group and the second chain end of said first and second PFPE chain are bonded to each other via:
a first block [block (1)] complying with formula (I):

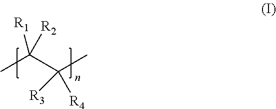

wherein
n is an integer from 1 to 3;
R₁ to R₄, each independently, is selected in the group comprising, preferably consisting of, fluorine atom, perfluorinated linear or branched alkyl group having from 1 to 6 carbon atoms, group of formula (II):

—(R₁₀)ₜ[C(R₁)(R₁₂)—C(R₁₃)(R₁₄)(R₁₅)]_{z} (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected in the group comprising, preferably consisting of, fluorine atom, perfluorinated linear or branched alkyl group having from 1 to 6 carbon atoms and group of formula (III):

—[(A\hat{ })_{a\hat{ }}-(B\hat{ })_{v\hat{ }}-(E\hat{ })_{L\hat{ }}]_{u\hat{ }}-(C\hat{ })-T (III)
wherein
a\hat{ } is zero or 1,
v\hat{ } is zero or an integer from 1 to 3,
L\hat{ } is an integer from 1 to 250, preferably from 2 to 250,
u\hat{ } is zero or an integer from 1 to 50;
A\hat{ } is a PFPE chain,
B\hat{ } is a group of formula

—[C(R_{1\hat{ }})(R_{2\hat{ }})—C(R_{3\hat{ }})(R_{4\hat{ }})]—
wherein R_{1\hat{ }} to R_{4\hat{ }} each independently has the meaning defined above for each of R₁ to R₄,
E\hat{ } is a group of formula

—(CR_{100\hat{ }}R_{101\hat{ }}CR_{102\hat{ }}R_{103\hat{ }})—
wherein
R_{100\hat{ }} and R_{101\hat{ }} are independently selected from halogen atom, more preferably fluorine or chlorine atom, and
R_{102\hat{ }} and R_{103\hat{ }} are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
and
a second block [block (2)] complying with formula (IV):

—[(CR^{1*}R^{2*}CR^{3*}R^{4*})_{n*}-(E)_{L}*]- (IV)
wherein
n* is 0 or an integer from 1 to 10, preferably from 1 to 5, more preferably from 1 to 3, even more preferably 0 or 1,
L* is 0 or an integer from 1 to 250, more preferably from 2 to 250; each of R^{1*} to R^{4*} is selected in the group comprising, preferably consisting of, fluorine atom, perfluorinated linear or branched alkyl group having from 1 to 6 carbon atoms, group of formula (II) as defined above,
E has the same meaning provided for E\hat{ } above;
with the proviso that:
in said copolymer (P-2):
   the sum of (n+n*+v) is from 1 to 15, preferably from 1 to 11, more preferably from 1 to 9;
   the sum of (L\hat{ }+L*) is from 1 to 500, preferably from 2 to 500, more preferably from 3 to 300, and
   said block (1) and said block (2) are statistically distributed; in said formula (I):
   at least one of R₁ to R₄ is a group of formula (II),
   one of R₁₁ or R₁₂ and one of R₁₃ to R₁₅, is a group of formula (III); and in said formula (III) and said formula (IV), the recurring units are statistically distributed, in said formula (III)
   when a is 1 at least one of v\hat{ } and L\hat{ } is different from 0 and
in said formula (IV)
   at least one of n* and L* is different from zero.

Preferably, in said copolymer (P-1) and in said copolymer (P-2), each of said (E) and (E\hat{ }) is a group of formula:

—(CR₁₀₀R₁₀₁CR₁₀₂R₁₀₃)_{L}—(CR₁₁₀R₁₁₁CR₁₁₂R₁₁₃)ₘ—
wherein
L and m are each independently an integer from 1 to 250, more preferably from 2 to 250, such that the sum of L+m is from 2 to 250;
R₁₀₀, R₁₀₁, R₁₁₀ and R₁₁₁ are independently selected from halogen atom, more preferably fluorine or chlorine atom, and
R₁₀₂, R₁₀₃, R₁₁₂ and R₁₁₃ are independently selected from halogen atom, more preferably fluorine or chlorine atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R₁₀₀ and R₁₀₁ and one of R₁₀₂ and R₁₀₃ are a fluorine atom and the other of R₁₀₀ and R₁₀₁ and the other of R₁₀₂ and R₁₀₃ together form a perhalogenated cyclic ring having from 4 to 6 members, optionally comprising heteroatoms, such as oxygen atoms; or
one of R₁₁₀ and R₁₁₁ and one of R₁₁₂ and R₁₁₃ are a fluorine atom and the other of R₁₁₀ and R₁₁₁ and the other of R₁₁₂ and R₁₁₃ together form a perhalogenated cyclic ring having from 4 to 6 members, optionally comprising heteroatoms, such as oxygen atoms;
with the proviso that —(CR₁₀₀R₁₀₁CR₁₀₂R₁₀₃)_{L}— and —(CR₁₁₀R₁₁₁CR₁₁₂R₁₁₃)ₘ— are different from each other and statistically distributed.

Copolymers (P) according to the present invention can be advantageously prepared via a process that can be easily scaled up.

Preferably, in the process (P) of the present invention, the amount of the compound of formula (X-p) is less than 3 wt. %, even more preferably less than 1 wt. %, of the amount of the PFPE peroxy.

Preferably, said PFPE peroxy is a peroxidic (per)fluoropolyether polymer comprising a (per)fluoropolyether chain having two chain ends, each of said chain ends comprising a (per)fluorinated alkyl chain having from 1 to 3 carbon atoms, optionally containing one or more chlorine atoms or functional end groups selected from acyl fluoride, fluoroformate and ketones, said chain ends being bonded to opposite sides of said (per)fluoropolyether chain, said (per)fluoropolyether chain comprising, preferably consisting of, repeating units being independently selected from the group consisting of formulae (Rf-i) to (Rf-v) as above defined and having a peroxidic content (PO), defined as grams of active oxygen (Mw=16) in 100 g of PFPE peroxy between 0.1 and 4, preferably between 0.1 and 3.5.

The PFPE peroxy can be used as such or it can be subjected to partial reduction of the peroxid bonds, for example by chemical reduction or UV treatment or thermal treatment.

Preferably, in said compound of formula (X-p), when t is 1, the one, two, three or four unsaturated moieties are bonded to the same or different atoms, preferably carbon atoms, belonging to R₁₀.

Preferably, said at least one compound of formula (X-p) complies with the following formula:

CF₂═CF(R₁₀)ₜCF═CF₂
wherein t is zero or 1,
R₁₀ complies with one of the following formulae:

—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and
R_{CF} is either a perfluoroalkyl chain comprising from 1 to 12, preferably from 1 to 8 carbon atoms, optionally interrupted by one or more oxygen atoms

—O—(C₃F₆O)ₕ—(CF₂)ᵢ—(C₃F₆O)ⱼ—O— (R₁₀-ii)
wherein h=j and h+j is from 2 to 6, and i is from 2 to 6.

Preferably, said compound of formula (X-p) is selected from the group comprising, more preferably consisting of:
CF₂═CFCF═CF₂
CF₂═CFOCF═CF₂
CF₂═CFCF₂OCF₂CF═CF₂
CF₂═CFO—(CF₂)₃CF═CF₂
CF₂═CFCF₂O(CF₂)₃OCF₂—CF═CF₂
CF₂═CFCF₂CF═CF₂
CF₂═CF(CF₂)₂CF═CF₂
CF₂═CF(CF₂)₃CF═CF₂
CF₂═CF(CF₂)₄CF═CF₂
CF₂═CFOCF₂OCF═CF₂
CF₂═CFO(CF₂)₂OCF═CF₂
CF₂═CFO(CF₂)₃OCF═CF₂
CF₂═CFO(CF₂)₄OCF═CF₂
CF₂═CF(CF₂)₂OCF═CF₂
CF₂═CF(CF₂)₃OCF═CF₂
CF₂═CF(CF₂)₄OCF═CF₂
CF₂═CFCF₂O(CF₂)₂OCF₂O—CF═CF₂
CF₂═CFCF₂O(CF₂)₃OCF₂O—CF═CF₂
CF₂═CFCF₂O(CF₂)₄OCF₂OCF═CF₂
CF₂═CFCF₂O(CF₂)₆OCF₂CF═CF₂
CF₂═CFO—CF₂O—(CF₂)₂O—CF₂O—CF═CF₂
CF₂═CFO—CF₂O—(CF₂)₃O—CF₂O—CF═CF₂
CF₂═CFO—CF₂O—(CF₂)₄O—CF₂O—CF═CF₂
CF₂═CFO—(CF₂O)₆—CF═CF₂
CF₂═CFO—(CF₂CF₂O)₂—CF═CF₂
CF₂═CFO—(CF₂CF₂O)₂—CF₂OCF═CF₂
CF₂═CFO(C₃F₆₀)ₕ—(CF₂)ᵢ—(C₃F₆O)ⱼ—OCF═CF₂
wherein h and j are the same and
their sum is from 2 to 6 and i is from 2 to 6.

According to a particularly preferred embodiment, said at least one compound of formula (X-p) complies with the following formula:

CF₂═CF(R₁₀)ₜCF═CF₂
wherein t is 1 and
R₁₀ complies with formula:

—(CF₂)_{d}(O)ₑ(CF₂O)_{f}R_{CF}(O)_{e*}(CF₂)_{d*}(CF₂O)_{f*} (R₁₀-i)
wherein
d, f, d* and f* are zero,
e and e* are 1, and
R_{CF} is a linear perfluoroalkyl chain comprising from 1 to 10, preferably from 1 to 8 carbon atoms.

According to a preferred embodiment, process (P) of the invention is performed contacting said PFPE peroxy and said compound of formula (X-p) with at least two of said compounds (0).

Preferably, a first compound (O) is selected in the group comprising, preferably consisting of fully halogenated olefin comprising from 2 to 8 carbon atoms, such as tetrafluoroethylene (TFE), hexafluoropropylene (HFP), chlorotrifluoroethylene (CTFE). TFE and HFP being particularly preferred.

Preferably, a second compound (O) is selected in the group comprising, preferably consisting of:
(ii) CF₂═CFOR_{f},
wherein
R_{f} is a C₁-C₆ (per)fluoroalkyl group, preferably —CF₃, —C₂F₅, —C₃F₇ (also referred to as “PAVE” hereinafter); a group C₁-C₁₂ [(per)fluoro]-oxyalkyl comprising catenary oxygen atoms, preferably perfluoro-2-propoxypropyl group (also referred to as “perfluoro-oxy-alkyl-vinyl ethers” hereinafter); a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R_{f2} is —CF₂CF₃ (MOVE1), —CF₂CF₂OCF₃ (MOVE2), or —CF₃ (MOVE3);
(iii) perfluorodioxoles having formula

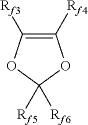

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃. PAVE and MOVE under definition (i) being particularly preferred.

According to a first embodiment, said process [process (P1)] for the manufacture of copolymer (P1) as defined above, said process (P1) comprising the steps of: a*) contacting at least one peroxidic (per)fluoropolyether polymer [PFPE peroxy] with
at least one perfluorinated compound of formula (X-p):

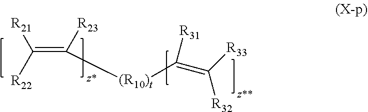

wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally and preferably interrupted by and/or comprising at least one oxygen atom,
t is zero or 1, preferably 1;
each of z* and z** is independently 1 or 2; and
at least one compound [compound (O)] selected in the group comprising, preferably consisting of:
(i) fully halogenated olefin comprising from 2 to 8 carbon atoms, such as tetrafluoroethylene (TFE), hexafluoropropylene (HFP), chlorotrifluoroethylene (CTFE);
(ii) CF₂═CFOR_{f},
wherein
R_{f} is a C₁-C₆ (per)fluoroalkyl group, preferably —CF₃, —C₂F₅, —C₃F₇ (also referred to as “PAVE” hereinafter); a group C₁-C₁₂ [(per)fluoro]-oxyalkyl comprising catenary oxygen atoms, preferably perfluoro-2-propoxypropyl group (also referred to as “perfluoro-oxy-alkyl-vinyl ethers” hereinafter); a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R_{f2} is —CF₂CF₃ (MOVE1), —CF₂CF₂OCF₃ (MOVE2), or —CF₃ (MOVE3);
(iii) perfluorodioxoles having formula:

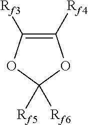

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃;
wherein
the amount of the compound of formula (X-p) is less than 5 wt. % of the amount of the PFPE peroxy;
b*) letting said PFPE peroxy, said compound of formula (X-p) and said at least one compound (O) react in the presence of UV radiation or heating;
c*) fluorinating, thus obtaining said copolymer (P1).

Preferably, said step (a*) comprises contacting said at least one PFPE peroxy with at least one compound of formula (X-p) and two of said compounds (0).

Preferably, a first compound (O) is selected in the group comprising, preferably consisting of fully halogenated olefin comprising from 2 to 8 carbon atoms, such as tetrafluoroethylene (TFE), hexafluoropropylene (HFP), chlorotrifluoroethylene (CTFE). TFE and HFP being particularly preferred.

Preferably, a second compound (O) is selected in the group comprising, preferably consisting of:
(ii) CF₂═CFOR_{f},
wherein
R_{f} is a C₁-C₆ (per)fluoroalkyl group, preferably —CF₃, —C₂F₅, —C₃F₇ (also referred to as “PAVE” hereinafter); a group C₁-C₁₂ [(per)fluoro]-oxyalkyl comprising catenary oxygen atoms, preferably perfluoro-2-propoxypropyl group (also referred to as “perfluoro-oxy-alkyl-vinyl ethers” hereinafter); a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R_{f2} is —CF₂CF₃ (MOVE1), —CF₂CF₂OCF₃ (MOVE2), or —CF₃ (MOVE3);
(iii) perfluorodioxoles having formula

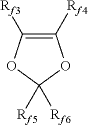

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃. PAVE and MOVE under definition (i) being particularly preferred.

Step (a*) and step (b*) can be performed in the presence of a fluorinated solvent. Preferably said fluorinated solvent is selected in the group comprising: perfluorocarbons, hydrofluorocarbons, perfluoropolyethers, hydrofluoropolyethers.

Preferably, step (b*) is performed in the presence of UV radiation for a time from 2 to 60 hours.

Preferably, step (b*) is performed in the presence of UV radiation at a temperature from −60° C. to +60° C., more preferably from −20° C. to +40° C. and even more preferably from 0° C. to 30° C.

As an alternative, step (b*) can be performed under thermal treatment, preferably by heating at a temperature from 100° C. to 250° C.

It will be clear to those skilled in the art that the polymer obtained at the end of step (b*) has a peroxide content (PO) lower than 0.05, preferably lower than 0.001.

Preferably, said step (c*) is performed by treating with fluorine in the presence of anhydrous nitrogen flow.

Preferably, said step (c*) is performed in the presence of UV radiation or under heating. Alternatively, said step (c*) can be performed as chemically assisted fluorination.

Preferably, said process (P1) comprises after step (c*), step (d*) of removal of the solvent and/or step (e*) of fractionation.

Said step (d*) of removal of the solvent can be carried out by evaporation, for example by distillation under vacuum.

Said step (e*) of fractionation can be performed via solvent extraction, using supercritical CO₂, hexafluoroxylene or hydrofluorocarbons as solvents, and mixtures thereof when the fractionation step is performed via precipitation fractionation. Supercritical CO₂ is preferred.

As explained above, although purification steps can be performed, it will be clear to those skilled in the art that at the end of process (P1), copolymers (P) according to the present invention are obtained in the form of mixtures comprising more then one copolymer (P) each characterized by different viscosities and/or molecular weight and/or substituents.

According to a second embodiment, the process [process (P2-a)] for the manufacture of copolymer (P2) comprises the steps of:
a′) contacting at least one peroxidic (per)fluoropolyether polymer [PFPE peroxy] with at least one one compound (O) as defined above;
b′) letting said PFPE peroxy and said compound (O) react in the presence of UV radiation or heating;
c′) stopping said UV radiation or heating;
d′) contacting the reaction mixture with at least one perfluorinated compound of formula (X-p):

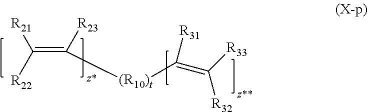

wherein
each of R₂₁ to R₂₃ and R₃₁ to R₃₃ is independently fluorine atom, perfluorinated alkyl group having from 1 to 3 carbon atoms, R₁₀ is an oxygen atom, or a perfluorinated alkyl chain comprising from 2 to 18 carbon atoms, preferably interrupted by and/or comprising at least one oxygen atom,
t is zero or 1, preferably 1;
each of z* and z** is independently 1 or 2,
wherein
the amount of the compound of formula (X-p) is less than 5 wt. % of the amount of the PFPE peroxy;
e′) letting the reaction proceed in the presence of UV radiation or heating; and
f′) fluorinating, thus obtaining said copolymer (P2).

Preferably, said step (a′) comprises contacting said at least one PFPE peroxy with at least two compounds (O).

Advantageously, a first compound (O) and a second compound (O) comply with the definition provided above.

Alternatively, the process [process (P2-b)] for the manufacture of copolymer (P2) comprises the steps of:
a″) contacting at least one peroxidic (per)fluoropolyether polymer [PFPE peroxy] with at least one perfluorinated compound of formula (X-p):

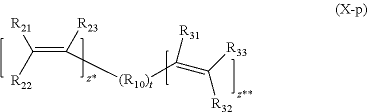

wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, preferably interrupted by and/or comprising at least one oxygen atom,
t is zero or 1, preferably 1;
each of z* and z** is independently 1 or 2,
wherein
the amount of the compound of formula (X-p) is less than 5 wt. % of the amount of the PFPE peroxy;
b″) letting said PFPE peroxy and said compound of formula (X-p) react in the presence of UV radiation or heating;
c″) stopping said UV radiation or heating;
d″) contacting the reaction mixture obtained in step c″) with at least one one compound (O) as defined above;
e″) letting the reaction proceed in the presence of UV radiation or heating; and f″) fluorinating, thus obtaining said copolymer (P2).

Preferably, said step (d″) comprises contacting the reaction mixture obtained in step (c″) with at least two compounds (O).

Advantageously, a first compound (O) and a second compound (O) comply with the definition provided above.

Steps (a′) to (c′) as well as steps (a″) to (c″) can be performed in the presence of a fluorinated solvent.

Preferably said fluorinated solvent is selected in the group comprising: perfluorocarbons, hydrofluorocarbons, perfluoropolyethers, hydrofluoropolyethers.

Preferably, step (b′) and step (b″) are each independently performed in the presence of UV radiation for a time from 2 to 60 hours.

Preferably, step (b′) and step (b″) are each independently performed in the presence of UV radiation at a temperature from −60° C. to +60° C., more preferably from −20° C. to +40° C. and even more preferably from 0° C. to 30° C.

As an alternative, step (b′) and step (b″) are each independently performed under thermal treatment, preferably by heating at a temperature from 100° C. to 250° C.

It will be clear to those skilled in the art that the polymer obtained at the end of step (c′) or step (c″) has a peroxide content (PO) lower than 0.05, preferably lower than 0.001.

Preferably, said step (f′) and step (f″) are each performed by treating with fluorine in the presence of anhydrous nitrogen flow.

Preferably, said step (f′) and step (f″) are each performed in the presence of UV radiation or under heating. Alternatively, step (f′) and step (f″) are each performed as chemically assisted fluorination.

Preferably, said process (P2-a) and said process (P2-b) comprises after step (f′) and (f′), respectively, step (g′) and step (g″) of removal of the solvent and/or step (h′) and step (h″) of fractionation.

Said step (g′) or (g″) of removal of the solvent can be carried out by evaporation, for example by distillation under vacuum.

Said step (h′) or (h″) of fractionation can be performed via solvent extraction, using supercritical CO₂, hexafluoroxylene or hydrofluorocarbons as solvents, and mixtures thereof when the fractionation step is performed via precipitation fractionation. Supercritical CO₂ is preferred.

As explained above, although purification steps can be performed, it will be clear to those skilled in the art that at the end of process (P), process (P1), process (P2-a) and process (P2-b) step (c) or of step (d) of process (P) as mixture (P), copolymers (P) according to the present invention are obtained in the form of mixtures comprising more then one copolymer (P) each characterized by different viscosities and/or molecular weight and/or substituents.

Copolymer (P) is advantageously used as a lubricant, notably for application in harsh environments, for example subjected to a wide range of working temperatures.

Copolymer (P) or mixture (P) can be used as such, or in admixture with additive(s) known to the person skilled in the art of lubrication, so that a composition [composition (CL)] is obtained.

For example, composition (CL) can comprise other suitable lubricants as base oil, such base oil being selected in the group comprising partially fluorinated, fully fluorinated and hydrogenated base oils, provided that said base oil is capable of forming a solution with copolymer (P).

Non-limiting examples of fully fluorinated lubricant base oils are those identified as compounds (1)-(8) EP 2100909 A (SOLVAY SOLEXIS S.p.A.).

For example, suitable additives are selected from thickening agents, anti rust agents, antioxidants, thermal stabilizers, pour-point depressants, anti-wear agents, including those for high pressures, dispersants, tracers, dyestuffs, talc and inorganic fillers.

Examples of thickening agents are talc, silica, boron nitride, polyureas, alkali or alkali-earth metals terephthalates, calcium and lithium soaps and complexes thereof and PTFE (polytetrafluoroethylene); among them, PTFE is preferred.

Examples of dispersants are, for example, surfactants, preferably non-ionic surfactants, more preferably (per)fluoropolyether surfactants and (per)fluoroalkyl surfactants.

If required by the application, solvents can also be used.

Examples of solvents are fluorinated or partially fluorinated solvents, such as Galden® PFPEs, Novec® HFEs and other organic solvents like fluoro-alkane, fluoro-aromatic compound, fluoroalkyl ether, fluoroalkyl amine, fluoro-alcohol, ketone such as methyl-ethyl-ketone, alcohol such as isopropyl alcohol, ester such as butyl acetate, hydrofluorocarbons, and the like.

Thus, in a further aspect, the present invention relates to a method for lubricating at least one surface of at least one article, said method comprising contacting said copolymer (P) or said mixture (P) with said at least one surface.

The article that can benefit from the lubricant properties of copolymer (P), mixture (P) or composition (CL) according to the present invention is not particularly limited.

Said article preferably comprises at least one metal surface.

Examples of said article are pumps for use in oil and gas applications, such as electrical submersible pump and the like, rotary machines, such as steam turbines and gas turbines; electrical connectors; bearings of fan clutches or cooling fans; or heavy duty truck automatic clutches, more particularly bearings of said clutches.

Copolymer (P), mixture (P) or composition (CL) according to the present invention can be advantageously used as damper fluids in a damping device.

Thus, in a further aspect, the present invention relates to a method for counteract vibrations and/or shocks in a device, said method comprising providing an apparatus comprising a damper device, said damper device comprising at least one copolymer (P), mixture (P) or composition (CL) as defined above.

Should the disclosure of any patents, patent applications, and publications which are incorporated herein by reference conflict with the description of the present application to the extent that it may render a term unclear, the present description shall take precedence.

The invention will be now described in connection with the following examples, whose purpose is merely illustrative and not intended to limit the scope of the invention.

### EXPERIMENTAL SECTION

### Materials

Peroxidic perfluoropolyether oil having formula

T-O—(CF₂CF₂O)ₘ(CF₂O)ₙ—(O)ₕ-T′
number average molecular weight (Mₙ)=48600 g/mol,
m/n=1.0 and PO=1.65%
T, T′=—CF₃ (83%), —C(═O)F (6%), —CF₂C(═O)F (11%) was obtained by Solvay Specialty Polymers Italy S.p.A.

Tetrafluoroethylene (TFE), perfluoro(methyl vinyl ether) (PMVE) and Galden® HT200 were obtained by Solvay Specialty Polymers Italy S.p.A.

Perfluoro(bis vinyl ether) (PBVE) was obtained by Anles Ltd..

Hexafluorobenzene was obtained by Sigma Aldrich.

### Methods

### 19F-NMR Spectroscopy:

Varian Mercury 200 MHz spectrometer working for the fluorine nucleus was used to obtain the structure, the number average molecular weight and the composition of the PFPE oils reported in the following examples. The ¹⁹F-NMR spectrum was obtained on pure samples using CFCl₃ as internal reference. Hexafluorobenzene was also used as a solvent.

### Determination of the Peroxidic Content (PO):

The peroxidic content (PO) is expressed as grams of peroxidic oxygen per 100 g of polymer. The analysis of the peroxide content was carried out by iodometric titration using a Mettler DL40 device equipped with platinum electrode. The sensitivity limit for the PO determination was 0.0002%.

### Determination of the Complex Viscosity:

The complex viscosity was measured with frequency sweep tests using an MCR502 Anton-Paar rheometer with parallel plate geometry (25 mm diameter) according to ISO 6271 part 10.

### Gel Permeation Chromatography (GPC):

The analysis was performed with a Mixed CCD column with a Waters 410 refractometer detector using HFE7100 as eluent.

### Example 1—Synthesis of Copolymer (1)

The reaction was performed using a 1000 mL cylindrical photochemical glass reactor equipped with a high-pressure mercury lamp (HANAU TQ150) enclosed in a quartz cylinder, a magnetic stirrer, a thermocouple and a condenser.

200.0 g of the starting peroxidic perfluoropolyether oil were charged in the photochemical reactor together with 1499 g of Galden® HT200 and stirred thoroughly to obtain a homogenous mixture. The reaction mixture was then cooled down to about 10° C. with an ice/water bath.

Two fluorinated olefins, PMVE and TFE, were introduced into the reactor, at a rate of 2.20 and 1.60 NI/h, respectively. After the flow started, the UV lamp was switched on. After 4 h, the UV lamp was switched off and 1.31 g of PBVE were added to the reactor. Under vigorous stirring and nitrogen, the UV lamp was switched on again.

After 51 hours of irradiation, the lamp was switched off and the reaction mixture was transferred into a second glass reactor and fluorinated at 40° C. with 1.0 NI/h of fluorine gas for a total of 24 hours in the presence of UV radiation. ¹⁹F-NMR analysis confirmed the complete fluorination of the product and the absence of —CF₂COF and —COF terminals at the chain ends.

The obtained solution was distilled at 240° C. for 4 h in a round bottom flask equipped with a magnetic stirrer in order to remove the solvent.

The distillation was conducted first at atmospheric pressure, then under reduced pressure (0.1 mbar) until complete removal of the solvent.

203.4 g of copolymer (1) in the form of a clear viscous oil were obtained as residue, which was analyzed by iodometric titration to confirm the complete removal of the peroxide units.

¹⁹F-NMR analysis confirmed the absence of residual peroxide and the incorporation of TFE and PMVE at a concentration respectively of 10.2 and 10.1 weight %.

Copolymer (1) had m/n=0.96, and the chain ends T, T′=—CF₃.

### Example 2—Synthesis of Copolymer (2)

The same photochemical apparatus and peroxidic perfluoropolyether precursor as Example 1 were adopted for this example.

200.8 g of the starting peroxidic perfluoropolyether oil were charged in the photochemical reactor together with 1494 g of Galden HT200 and 1.35 g of PBVE and stirred thoroughly to obtain a homogenous mixture.

The reaction mixture was then cooled down to about 10° C. by means of an ice/water bath. Two fluorinated olefins, PMVE and TFE, were introduced into the reactor, at a rate of 2.20 and 1.60 NI/h respectively. Immediately after the olefin flow started, the UV lamp was switched on. After 4 h, the olefins flow was interrupted and the reaction continued for 51 h under UV radiation.

The lamp was switched off and the reaction mixture was transferred into a second glass reactor to be fluorinated at 40° C. with 1.0 NI/h of fluorine gas for a total of 24 hours in the presence of UV radiation.

¹⁹F-NMR analysis confirmed the complete fluorination of the product and absence of —COF, —CF₂COF terminals at the chain ends.

The obtained solution was distilled at 240° C. for 4 h in a round bottom flask equipped with a magnetic stirrer in order to remove the solvent. The distillation was conducted first at atmospheric pressure, then under reduced pressure (0.1 mbar) until complete removal of the solvent.

205.8 g of copolymer (2) in the form of a clear viscous oil were obtained as residue, which was analyzed by iodometric titration to confirm the complete removal of the peroxide units.

¹⁹F-NMR analysis confirmed the absence of residual peroxide and the incorporation of TFE and PMVE at a concentration respectively of 8.8 and 11.8 weight %.

Copolymer (2) had m/n=0.99, T, T′=—CF₃.

### Example 3C—Synthesis of Comparative Polymer (C-1\hat{ }) without PBVE

The same photochemical apparatus and peroxidic perfluoropolyether precursor as Example 1 were adopted for this comparative example.

200.4 g of the starting peroxidic perfluoropolyether oil were charged in the photochemical reactor together with 1502 g of Galden® HT200 and stirred thoroughly to obtain a homogenous mixture.

The reaction proceeded as described in Example 2. The reaction mixture was then cooled down to about 10° C. by means of an ice/water bath. Two fluorinated olefins, PMVE and TFE, were introduced into the reactor, at a rate of 2.20 and 1.60 NI/h respectively. Immediately after the olefin flow started, the UV lamp was switched on. After 4 h, the olefins flow was interrupted and the reaction continued for 51 h under UV radiation.

¹⁹F-NMR analysis confirmed the complete fluorination of the product and the absence of —CF₂COF and —COF terminals at the chain ends.

Distillation was also performed as described in Example 2.

206.3 g of comparative polymer (C-1\hat{ }) in the form of a clear viscous oil were obtained as residue, which was analyzed by iodometric titration to confirm the complete removal of the peroxide units.

¹⁹F-NMR analysis confirmed the absence of residual peroxide. Comparative copolymer (C-1\hat{ }) had m/n=1.0 and T, T′=—CF₃.

TABLE 1

| | | Complex viscosity (at |
|---|---|---|
| | Mw (g/mol) | 0.1 rad/s and 25° C.) |
| Copolymer (1) | 126300 | 122.3 Pa*s |
| Copolymer (2) | 236600 | 460.0 Pa*s |
| Comparative polymer (C-1\hat{ }) | 105000 | 20.5 Pa*s |

The increased molecular weight distribution and complex viscosity of copolymer (1) and (2) according to the present invention confirmed the chain extension with respect to the comparative polymer (C-1\hat{ }).

1. A block copolymer [copolymer (P)] comprising a first and a second (per)fluoropolyether chain [PFPE chain] each having two chain ends, wherein the first chain end of said first and second PFPE chain comprises a perfluorinated alkyl group and the second chain end of said first and second PFPE chain are bonded to each other via:—a first block [block (1)] complying with formula (I): 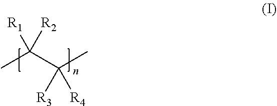
wherein
n is 0 or an integer from 1 to 3;
R₁ to R₄, each independently, is selected from the group consisting of fluorine atom, perfluorinated linear or branched alkyl group having from 1 to 6 carbon atoms, group of formula (II):
—(R₁₀)ₜ[C(R₁₁)(R₁₂)—C(R₁₃)(R₁₄)(R₁₅)]_{z} (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected from the group consisting of fluorine atom, perfluorinated linear or branched alkyl group having from 1 to 6 carbon atoms and group of formula (III):
—[(A\hat{ })_{a\hat{ }}-(B\hat{ })_{v\hat{ }}-(E\hat{ })_{L\hat{ }}]_{u\hat{ }}-(C\hat{ })-T (III)
wherein
a\hat{ } is zero or 1,
v\hat{ } is zero or an integer from 1 to 3,
L\hat{ } is zero or an integer from 1 to 250,
u\hat{ } is zero or an integer from 1 to 50;
A\hat{ } is a PFPE chain
B\hat{ } is a group of formula:—[C(R_{1\hat{ }})(R_{2\hat{ }})—C(R_{3\hat{ }})(R_{4\hat{ }})]—
wherein
R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, and
R_{102\hat{ }} and R_{103\hat{ }} are independently selected from halogen atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
and
a second block [block (2)] complying with formula (IV): —[(CR^{1*}R^{2*}CR^{3*}R^{4*})_{n*}-(E)_{L}]- (IV)
wherein
n* is zero or an integer from 1 to 10,
L is zero or an integer from 1 to 250;
each of R^{1*} to R^{4*} is selected from the group consisting of fluorine atom, perfluorinated linear or branched alkyl group having from 1 to 6 carbon atoms, group of formula (II) as defined above,
E has the same meaning provided for E\hat{ } above;
with the proviso that:
in said copolymer (P)
the sum of (n+n*+v\hat{ }) is from 1 to 15;
the sum of (L+L\hat{ }) is from 1 to 500,
said block (1) and said block (2) are statistically distributed;
in said formula (I):
at least one of R₁ to R₄ is a group of formula (II),
one of Rₙ or R₁₂ and one of R₁₃ to R₁₅, is a group of formula (III);
in said formula (III) and said formula (IV)
the recurring units are statistically distributed,
in said formula (III)
when a is 1 at least one of v\hat{ } and L\hat{ } is different from 0, and
in said formula (IV)
at least one of n* and L is different from zero.

2. The copolymer (P) according to claim 1, wherein:
said first chain end of said first and second PFPE chain and said T in formula (III), equal or different from each other, are a perfluorinated alkyl group having from 1 to 3 carbon atoms; and/or
said first and second PFPE chain, said A\hat{ } and said C\hat{ } are equal or different from each other; and/or
said first PFPE chain is bonded to said block (1) via a sigma bond or a group —(C)— selected from —CF₂—, —CF₂CF₂— or —O—; and/or
said block (2) is bonded to said second PFPE chain via a sigma bond or a group —(C)— selected from —CF₂—, —CF₂CF₂— or —O—; and/or
each of said PFPE chain is a partially or fully fluorinated chain [chain (R_{f})] comprising, repeating units R^{o}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

3. The copolymer (P) according to claim 1, wherein in formula (II):
t is 0; or
t is 1 and R₁₀ complies with one of the following formulae:
—(CF₂)_{d}(O)ₑ(CF₂O)_{f}R_{CF}(O)_{e*}(CF₂)_{d*}(CF₂O)_{f*} (R₁₀-i)
wherein
each of d, d*, e, e*, f and f* is independently zero or 1 and R_{CF} is either a perfluoroalkyl chain comprising from 1 to 12, optionally interrupted by one or more oxygen atoms,
—O—(C₃F₆O)ₕ—(CF₂)ᵢ—(C₃F₆O)ⱼ—O— (R10-ii)
wherein h=j and h+j is from 2 to 6, and i is from 2 to 6.

4. The copolymer (P) according to claim 1, wherein in formula (II):
z is equal to 1 and R₁₀ is an oxygen atom or a bivalent perfluorinated alkyl chain comprising from 1 to 24 carbon atoms optionally interrupted by and/or comprising at least one oxygen atom; and/or
one of substituents R₁₁ and R₁₂ is a group of formula (III) and the other substituent is selected from a fluorine atom or a perfluorinated alkyl chain having from 1 to 3 carbon atoms; and/or
one of substituents R₁₃ to R₁₅ is a group of formula (III) and the other two substituents are independently selected from a fluorine atom or a perfluorinated alkyl chain having from 1 to 3 carbon atoms.

5. The copolymer (P) according to claim 1, wherein:
in formula (III), -(E\hat{ })_{L\hat{ }}- complies with the following formula:
—(CR_{100\hat{ }}R_{101\hat{ }}CR_{102\hat{ }}R_{103\hat{ }})_{l\hat{ }}-(CR_{110\hat{ }}R_{111\hat{ }}CR_{112\hat{ }}R_{113\hat{ }})_{m\hat{ }}—
wherein
l\hat{ } and m\hat{ } are each independently an integer from 1 to 250, such that the sum of L+m is from 2 to 250;
R_{100\hat{ }}, R_{101\hat{ }}, R_{110\hat{ }} and R_{111\hat{ }} are independently selected from halogen atom, and
R_{102\hat{ }}, R_{103\hat{ }}, R_{112\hat{ }} and R_{113\hat{ }} are independently selected from halogen atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms; or
one of R_{110\hat{ }} and R_{111\hat{ }} and one of R_{112\hat{ }} and R_{113\hat{ }} are a fluorine atom and the other of R_{110\hat{ }} and R_{111\hat{ }} and the other of R_{112\hat{ }} and R_{113\hat{ }} together form a perhalogenated cyclic ring having from 4 to 6 members, optionally comprising heteroatoms, such as oxygen atoms;
with the proviso that —(CR_{100\hat{ }}R_{101\hat{ }}CR_{102\hat{ }}R_{103\hat{ }})_{l\hat{ }}— and —(CR_{110\hat{ }R}_{111\hat{ }}CR_{112\hat{ }}R_{113\hat{ }})_{m\hat{ }}— are different from each other and statistically distributed; and/or
in formula (IV), -(E)_{L}- complies with the following formula:
—(CR₁₀₀R₁₀₁CR₁₀₂R₁₀₃)ₗ—(CR₁₁₀R₁₁₁CR₁₁₂R₁₁₃)ₘ—
wherein
each of l, m, R₁₀₀, R₁₀₁, R₁₁₀, R₁₁₁, R₁₀₂, R₁₀₃, R₁₁₂ and R₁₁₃ have the meanings defined above for l\hat{ }, m\hat{ }, R_{100\hat{ }}, R_{101\hat{ }}, R_{110\hat{ }}, R_{111\hat{ }}, R_{102\hat{ }}, R_{103\hat{ }\hat{ }}, R_{112\hat{ }} and R_{113\hat{ }} respectively.

6. The copolymer (P) according to claim 1, said copolymer (P) being free from pendant groups comprising any moiety capable of undergoing a further chemical reaction, such as unsaturated moieties.

7. The copolymer (P) according to claim 1, said copolymer (P) being a block copolymer [(P-1)] comprising a first and a second PFPE chain, each having two chain ends, wherein the first chain end of said first and second PFPE chain comprises a perfluorinated alkyl group and the second chain end of said first and second PFPE chain are bonded to each other via:
a block complying with formula (IV):
—[(CR^{1*}R^{2*}CR^{3*}R^{4*})_{n*}-(E)_{L}]- (IV)
Wherein
n* is an integer from 1 to 10;
L is zero or an integer from 1 to 250;
each of R^{1*} to R^{4*} is selected from the group consisting of fluorine atom, perfluorinated linear or branched alkyl group having from 1 to 3 carbon atoms, group of formula (II):
—(R₁₀)ₜ[C(R₁₁)(R₁₂)—C(R₁₃)(R₁₄)(R₁₅)]_{z} (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected from the group consisting of fluorine atom, perfluorinated linear or branched alkyl group having from 1 to 3 carbon atoms and group of formula (III):
—[(A\hat{ })_{a\hat{ }}-(B\hat{ })_{v\hat{ }}-(E\hat{ })_{L\hat{ }}]_{u\hat{ }}-(C\hat{ })-T (III)
Wherein
a\hat{ } is zero or 1,
v\hat{ } is zero or an integer from 1 to 3,
L\hat{ } is an integer from 1 to 250,
u\hat{ } is an integer from 1 to 50;
A\hat{ } is a PFPE chain,
B\hat{ } is a group of formula —[C(R_{1\hat{ }})(R_{2\hat{ }})—C(R_{3\hat{ }})(R_{4\hat{ }})]—
wherein
R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, and
R_{102\hat{ }} and R_{103\hat{ }} are independently selected from halogen atom linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
E has the same meaning provided for E\hat{ } above;
with the proviso that
in said copolymer (P-1):
the sum of (n*+v\hat{ }) is from 1 to 15,
the sum of (L+L\hat{ }) is from 2 to 500, and
the recurring units in formulae (III) and (IV) are statistically distributed; and
in said formula (IV):
at least one of R_{1\hat{ }} to R_{4\hat{ }} is a group of formula (II),
one of R₁₁ or R₁₂ and one of R₁₃ to R₁₅, is a group of formula (III).

8. The copolymer (P)) according to claim 1, said copolymer (P) being a block copolymer [(P-2)] comprising a first and a second PFPE chain, each having two chain ends, wherein the first chain end of said first and second PFPE chain comprises a perfluorinated alkyl group and the second chain end of said first and second PFPE chain are bonded to each other via:
a first block [block (1)] complying with formula (I):
(I) 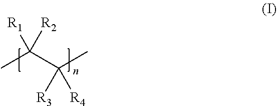
wherein
n is an integer from 1 to 3;
R₁ to R₄, each independently, is selected from the group consisting of fluorine atom, perfluorinated linear or branched alkyl group having from 1 to 6 carbon atoms, group of formula (II):
—(R₁₀)ₜ[C(R₁₁)(R₁₂)—C(R₁₃)(R₁₄)(R₁₅)]_{z}, (II)
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected from the group consisting of fluorine atom, perfluorinated linear or branched alkyl group having from 1 to 6 carbon atoms and group of formula (III):
—[(A\hat{ })_{a\hat{ }}-(B\hat{ })_{v\hat{ }}-(E\hat{ })_{L\hat{ }}]_{u\hat{ }}-(C\hat{ })-T (III)
wherein
a\hat{ } is zero or 1,
v\hat{ } is zero or an integer from 1 to 3,
L\hat{ } is an integer from 1 to 250,
u\hat{ } is zero or an integer from 1 to 50;
A\hat{ } is a PFPE chain,
B\hat{ } is a group of formula —[C(R_{1\hat{ }})(R_{2\hat{ }})—C(R_{3\hat{ }})(R_{4\hat{ }})]—
wherein
R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, and
R_{102\hat{ }} and R_{103\hat{ }} are independently selected from halogen atom; linear or branched alkyl chain comprising from 1 to 6 carbon atoms; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
and
a second block [block (2)] complying with formula (IV):
—[(CR^{1*}R^{2*}CR^{3*}R^{4*})_{n*}-(E)_{L*}]- (IV)
Wherein
n* is 0 or an integer from 1 to 10,
L* is 0 or an integer from 1 to 250;
each of R^{1*} to R^{4*} is selected from the group consisting of fluorine atom, perfluorinated linear or branched alkyl group having from 1 to 6 carbon atoms, group of formula (II) as defined above,
E has the same meaning provided for E\hat{ } above;
with the proviso that:
in said copolymer (P-2):
the sum of (n+n*+v) is from 1 to 15;
the sum of (L\hat{ }+L*) is from 1 to 500, and
said block (1) and said block (2) are statistically distributed; and
in said formula (I):
at least one of R₁ to R₄ is a group of formula (II),
one of Rₙ or R₁₂ and one of R₁₃ to R₁₅, is a group of formula (III); and
in said formula (III) and said formula (IV), the recurring units are statistically distributed,
in said formula (III)
when a is 1 at least one of v\hat{ } and L\hat{ } is different from 0 and
in said formula (IV), at least one of n* and L* is different from zero.

9. A mixture [mixture (P)] comprising two or more copolymers (P) as defined in claim 1.

10. A process [process (P)] for the manufacturing of copolymer (P) as defined in claim 1, said process (P) comprising at least one step of contacting:
at least one (per)fluoropolyether polymer comprising peroxidic groups [PFPE peroxy];
at least one perfluorinated compound of formula (X-p): 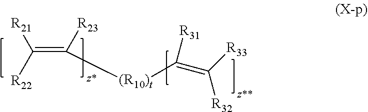
wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally interrupted by and/or comprising at least one oxygen atom,
t is zero or 1;
each of z* and z** is independently 1 or 2; and
at least one compound [compound (O)] selected from the group consisting of:
(i) fully halogenated olefin comprising from 2 to 8 carbon atoms;
(ii) CF₂═CFOR_{f},
wherein
R_{f} is a C₁-C₆ (per)fluoroalkyl group; a group C₁-C₁₂ [(per)fluoro]-oxyalkyl comprising catenary oxygen atoms; a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom;
(iii) perfluorodioxoles having formula: 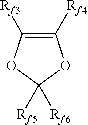
wherein each of R_{f3}, R_{f4}, R_{f5}, R_{f6}, equal to or different from each other, is independently selected from the group consisting of fluorine atom and C₁—C₆ perfluoroalkyl groups, optionally comprising one or more than one oxygen atom, such as notably —CF₃, —C₂F₅, —C₃F₇, —OCF₃, —OCF₂CF₂OCF₃;
in the presence of UV radiation or under heating,
provided that the amount of the compound of formula (X-p) is less than 5 wt. % of the amount of the PFPE peroxy.

11. The process (P) according to claim 10, wherein said PFPE peroxy is a peroxidic (per)fluoropolyether polymer comprising a (per)fluoropolyether chain having two chain ends, each of said chain ends comprising a (per)fluorinated alkyl chain having from 1 to 3 carbon atoms, optionally containing one or more chlorine atoms or functional end groups selected from acyl fluoride, fluoroformate and ketones, said chain ends being bonded to opposite sides of said (per)fluoropolyether chain, said (per)fluoropolyether chain comprising, repeating units being independently selected from the group consisting of formulae (Rf-i) to (Rf-v) as above defined and having a peroxidic content (PO), defined as grams of active oxygen (Mw=16) in 100 g of PFPE peroxy between 0.1 and 4.

12. The process (P) according to claim 10, wherein said at least one compound of formula (X-p) complies with the following formula:
CF₂═CF(R₁₀)ₜCF═CF₂
wherein
t is zero or 1,
R₁₀ complies with one of the following formulae:
—(CF₂)_{d}(O)ₑ(CF₂O)_{f}R_{CF}(O)_{e*}(CF₂)_{d*}(CF2O)_{f*} (R₁₀-i)
wherein
each of d, d*, e, e*, f and f* is independently zero or 1 and
R_{CF} is either a perfluoroalkyl chain comprising from 1 to 12, optionally interrupted by one or more oxygen atoms
—O—(C₃F₆O)ₕ—(CF₂)ᵢ—(C₃F₆O)ⱼ—O— (R₁₀-ii)
wherein h=j and h+j is from 2 to 6, and i is from 2 to 6.

13. The process (P) according to a claim 10, wherein two of said compounds (O) are used.

14. The process (P) according to claim 15, wherein
a first compound (O) is selected from the group consisting of fully halogenated olefin comprising from 2 to 8 carbon atoms; and
a second compound (O) is selected from the group consisting of:
(ii) CF₂═CFOR_{f},
wherein
R_{f} is a C₁-C₆ (per)fluoroalkyl group; a group C₁-C₁₂ [(per)fluoro]-oxyalkyl comprising catenary oxygen atoms; a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom;
(iii) perfluorodioxoles having formula: 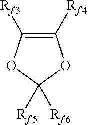
wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom.

15. A process [process (P1)] for the manufacture of polymer (P-1) as defined in claim 7, said process (P1) comprising the steps of:
a*) contacting at least one peroxidic (per)fluoropolyether polymer [PFPE peroxy] with
at least one perfluorinated compound of formula (X-p): 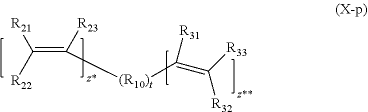
Wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally interrupted by and/or comprising at least one oxygen atom,
t is zero or 1;
each of z* and z** is independently 1 or 2; and
at least one compound [compound (O)] selected from the group consisting of:
(i) fully halogenated olefin comprising from 2 to 8 carbon atoms, such as tetrafluoroethylene (TFE), hexafluoropropylene (HFP), chlorotrifluoroethylene (CTFE);
(ii) CF₂═CFOR_{f},
wherein
R_{f} is a C₁-C₆ (per)fluoroalkyl group; a group C₁-C₁₂ [(per)fluoro]—oxyalkyl comprising catenary oxygen atoms; a group —CF₂OR_{f2} (also referred to as “perfluoro-methoxy-vinyl ethers” or “MOVE” hereinafter) wherein R₂ is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom;
(iii) perfluorodioxoles having formula: 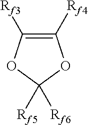
wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably —CF₃, —C₂F₅, —C₃F₇, —OCF₃, —OCF₂CF₂OCF₃;
wherein
the amount of the compound of formula (X-p) is less than 5 wt. % of the amount of the PFPE peroxy;
b*) letting said PFPE peroxy, said compound of formula (X-p) and said at least one compound (O) react in the presence of UV radiation or heating;
c*) fluorinating, thus obtaining said copolymer (P-1).

16. A process [process (P2-a)] for the manufacture of copolymer (P-2) as defined in claim 8, said process (P2-a) comprising the steps of:
a′) contacting at least one peroxidic (per)fluoropolyether polymer [PFPE peroxy] with at least one one compound (O) as defined above;
b′) letting said PFPE peroxy and said compound (O) react in the presence of UV radiation or heating;
c′) stopping said UV radiation or heating;
d′) contacting the reaction mixture with at least one perfluorinated compound of formula (X-p): 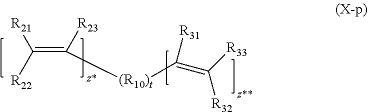
wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally interrupted by and/or comprising at least one oxygen atom,
t is zero or 1;
each of z* and z** is independently 1 or 2,
wherein
the amount of the compound of formula (X-p) is less than 5 wt. % of the amount of the PFPE peroxy;
e′) letting the reaction proceed in the presence of UV radiation or heating; and
f′) fluorinating, thus obtaining said copolymer (P2).

17. A process [process (P2-b)] for the manufacture of copolymer (P-2) as defined in claim 8, wherein said process (P2-b) comprises the steps of:
a″) contacting at least one peroxidic (per)fluoropolyether polymer [PFPE peroxy] with at least one perfluorinated compound of formula (X-p): 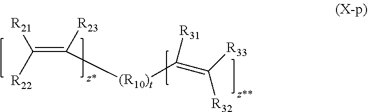
wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally interrupted by and/or comprising at least one oxygen atom,
t is zero or 1;
each of z* and z** is independently 1 or 2,
wherein
the amount of the compound of formula (X-p) is less than 5 wt. % of the amount of the PFPE peroxy;
b″) letting said PFPE peroxy and said compound of formula (X-p) react in the presence of UV radiation or heating;
c″) stopping said UV radiation or heating;
d″) contacting the reaction mixture obtained in step c″) with at least one one compound (O) as defined above;
e″) letting the reaction proceed in the presence of UV radiation or heating; and
f″) fluorinating, thus obtaining said copolymer (P2).

18. A composition [composition (CL)] comprising at least one copolymer (P) as defined in claim 1 or the mixture (P) comprising two or more copolymers (P), at least one base oil selected in the group comprising partially fluorinated, fully fluorinated and hydrogenated base oils, provided that said base oil is capable of forming a solution with said copolymer (P), and optionally at least one additive selected from thickening agents, antirust agents, antioxidants, thermal stabilizers, pour-point depressants, anti-wear agents, including those for high pressures, dispersants, tracers, dyestuffs, talc and inorganic fillers.

19. A method for lubricating at least one surface of at least one article, said method comprising contacting at least one copolymer (P) as defined in claim 1, or said mixture (P) comprising two or more copolymers (P) or said composition (CL) comprising at least one copolymer (P) or the mixture (P) comprising two or more copolymers, at least one base oil and optionally at least one additive with said at least one surface.

20. The method of claim 19, wherein said article is selected from pumps for use in oil and gas applications; rotary machines; electrical connectors; bearings of fan clutches or cooling fans; or heavy duty truck automatic clutches.

21. A method for counteract vibrations and/or shocks in a device, said method comprising providing an apparatus comprising a damper device, said damper device comprising at least one copolymer (P) as defined in claim 1, or said mixture (P) comprising two or more copolymers (P) or said composition (CL) comprising at least one copolymer (P) or the mixture (P) comprising two or more copolymers, at least one base oil and optionally at least one additive.
